(19) United States
(12) Patent Application Publication
(10) Pub. No.: US 2003/0016110 A1
(43) Pub. Date: Jan. 23, 2003

(54) Leakage flux protection for transformer clamping bar

(75) Inventors: Hasse Nordman, Vaasa (FI); Thomas Fogelberg, Ludvika (SE)

Correspondence Address: OLIFF & BERRIDGE, PLC, P.O. BOX 19928, ALEXANDRIA, VA, 22320, US

(73) Assignee: ABB TECHNOLOGY AG, ZURICH (CH)

(21) Appl. No.: 10/208,880

(22) Filed: Aug. 1, 2002

Related U.S. Application Data
(63) Continuation of application No. PCT/FI01/00191, filed on Feb. 23, 2001.

(30) Foreign Application Priority Data
Feb. 23, 2000 (FI) 20000419

(51) Int. Cl. H01F 17/06

(52) U.S. Cl. 336/175

(57) ABSTRACT

An arrangement for reducing leakage flux of a transformer or the like conducted to a clamping bar, and a transformer which comprises one or more leakage flux guides (10 to 17) for at least one transformer pole (3) provided with the windings (4), the leakage flux guides being arranged such that they are secured to the clamping bar (1), or in connection therewith, at points that are free from obstacles (20, 30) associated with the clamping bar such that they cover a portion of the clamping bar substantially at the windings and that the magnetic connection of the leakage flux guides to the core is better than the magnetic connection to the clamping bar, whereby they direct the conducted leakage flux mainly to the core reducing the conduction of the leakage flux to the clamping bar.

This application is a Continuation of International Application PCT/FI01/00191 filed on Feb. 23, 2001, which designated the U.S. and was published under PCT Article 21(2) in English.

### BACKGROUND OF THE INVENTION

The invention relates to reduction of leakage flux directed to clamping bars of transformers and corresponding electromagnetic devices.

Operation of a transformer is based on electric currents passing in its windings and the associated magnetic flux which advantageously passes in the core of the transformer. Part of the magnetic flux is conducted outside the core. This part is called leakage flux. The leakage flux causes, among other things, power losses in the metal structures of the transformer.

One core construction, particularly employed in connection with large transformers, is such that the transformer core is manufactured of laminated transformer plates and the plates are supported to one another by pressing them with clamping bars disposed on the sides of the core yokes. The clamping bars are generally of metal, whereby the leakage flux conducted thereto causes losses and thus makes them heat.

Various solutions are known for reducing leakage flux directed to clamping bars. One solution is to place conductors on the path of the leakage flux, in which conductors the leakage flux generates an electric current which, in turn, generates a flux opposite to the leakage flux, whereby the leakage flux is cancelled at least in part. Another basic solution is to conduct the leakage flux back to the core by means of specific magnetically conductive leakage flux guides. These solutions are presented, for instance, in GB 1015229 and GB 1270594.

The prior art solutions have a problem that their structures are often complicated and/or difficult to install. In addition, the solutions used for the protection of the clamping bar may require changes in the structure of the transformer clamping bar, which causes additional costs.

### BRIEF DESCRIPTION OF THE INVENTION

The object of the invention is thus to provide a method and equipment implementing the method such that the above-mentioned problems can be solved. This is achieved by an arrangement and a transformer, which are characterized by what is disclosed in the independent claims 1 and 6. The preferred embodiments of the invention are disclosed in the dependent claims.

The invention is based on protecting one or more clamping bars of a transformer substantially at the point of at least one transformer pole provided with windings, where the leakage flux is most powerful, by placing one or more leakage flux guides in the clamping bar or in connection therewith at points that are free from obstacles associated with the clamping bar. In the measurements carried out, the applicant has found that by this arrangement consisting of one or more leakage flux guides it is possible to reduce the leakage flux conducted to the clamping bar substantially, even though the whole area which is subject to the leakage flux would not be covered, because the leakage flux guide(s) adjacent to the unprotected area substantially reduce also the leakage flux directed to the unprotected area.

The arrangement and the transformer according to the invention have an advantage that the leakage flux protection of the clamping bar is flexible to install and simple to implement, and it does not necessarily require any particular arrangements in the structure of the clamping bar, whereby it can be applied to a plurality of existing transformer constructions without any specific changes in the transformer structure. Furthermore, the leakage flux protection according to the invention is economical to implement.

### BRIEF DESCRIPTION OF THE DRAWINGS

In the following, the invention will be described in greater detail in connection with preferred embodiments, with reference to the attached drawings, wherein

FIG. 1 is a partial view of a transformer illustrating the positioning of leakage flux guides in a clamping bar of the transformer according to one embodiment of the invention;

FIG. 2 is a cross-sectional view of the clamping bar of the transformer illustrating the securing of the leakage flux guide to the transformer clamping bar according to one embodiment of the invention; and

FIG. 3 is a cross-sectional view of the clamping bar of the transformer illustrating the securing of two superimposed leakage flux guides to the transformer clamping bar according to one embodiment of the invention.

### DETAILED DESCRIPTION OF THE INVENTION

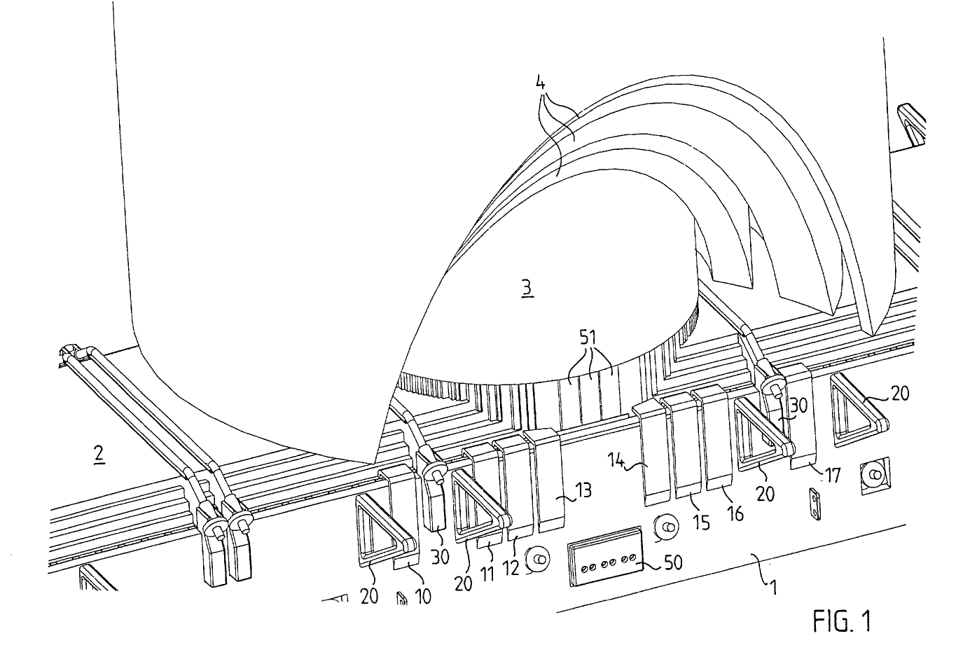

FIG. 1 shows a perspective view of a transformer part comprising a yoke 2 and a pole 3, which are a part of a transformer core, windings 4 (shown partly cut open) disposed on the pole 3 and a clamping bar 1 having a counterpart bar (not shown in the figure) on the opposite side of the yoke 2, and by which the core consisting of transformer plates are clamped together.

FIG. 1 further shows a set of leakage flux guides 10, 11, 12, 13, 14, 15, 16 and 17. According to the invention, the leakage flux guides 10 to 17 are placed in connection with the clamping bar 1 at such points where there are no other protruding parts associated with the clamping bar or other obstacles, such as support flanges 20 and bolt supports 30. The connection 50 of steel pull bars connecting the clamping bars of the upper yoke and the lower yoke are also left without protection in this example, because the pull bars 51 are located on the side of the pole 3, whereby the magnetic connection of the leakage flux guide to the core would be difficult to implement at said point. In the example of FIG. 1, eight separate leakage flux guides 10 to 17 are placed in the clamping bar 1 at the pole 3 provided with windings 4. However, the number of leakage flux guides 10 to 17 used depends on the structure of the specific clamping bar to be protected, and it may vary. It is essential to attempt to cover the clamping bar 1 areas free from other obstacles by the leakage guides 10 to 17 substantially at the pole provided with the windings 4, where the leakage flux is highest on the clamping bar 1. It is possible to place the leakage flux guides 10 to 17 in each clamping bar of the transformer at each pole provided with windings, or only in some of them. The leakage flux protection according to the invention can be combined, if necessary, to other possible systems reducing leakage flux, for instance, for complementing said systems.

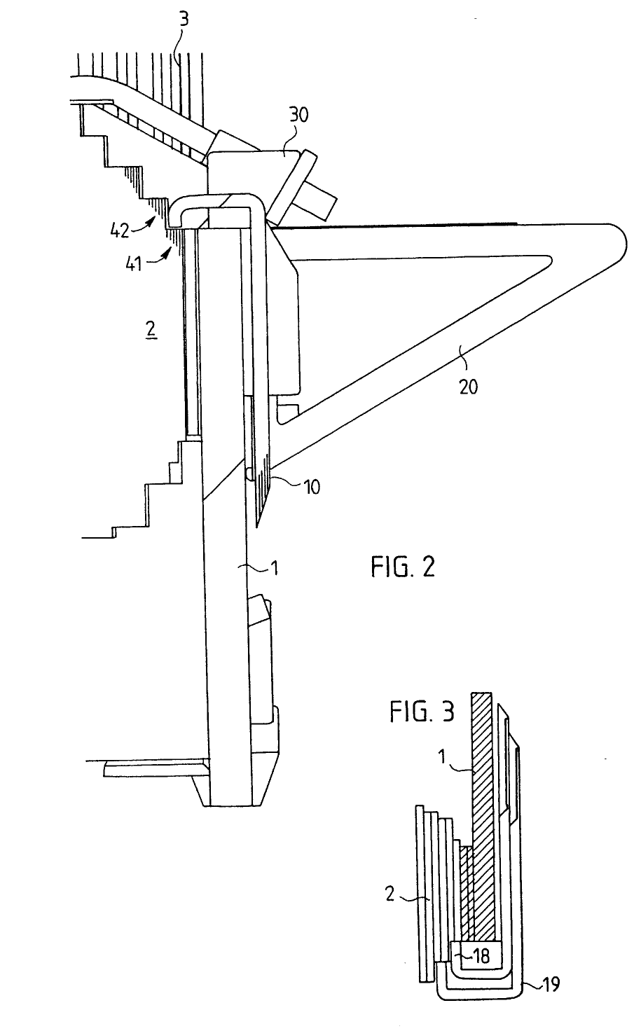

FIG. 2 shows a cross-section of the clamping bar 1 and the leakage flux guide 10 secured thereto. The leakage flux guide 10 is secured to the clamping bar 1 or in connection therewith such that magnetic connection from the leakage flux guide 10 to the transformer core, in this case to the yoke 2, is substantially better than the magnetic connection from the leakage flux guide 10 to the clamping bar 1. The leakage flux conducted to the leakage flux guide 10 is then further conducted mainly to the transformer core 2 and 3, and the leakage flux conducted to the clamping bar 1 reduces. In the case of FIG. 2, this is arranged such that the distance between the leakage flux guide 10 and the clamping bar 1 is 10 mm or more, whereas the distance between the leakage flux guide 10 and the first step of the yoke 2 is considerably smaller, i.e. about 1 mm. Said distance between the leakage flux guide and the clamping bar can be set, for instance, by using spacers of suitable thickness or corresponding supports in connection with securing the leakage flux guides, however, these are not shown in the figures for the sake of clarity. It should be noted that the measurement values presented herein are only intended to illustrate the invention, and naturally, they depend on the size of the whole transformer construction and the like. The leakage flux guide is advantageously kept without galvanic contact to the core 2 and 3 so as to avoid the risk of partial discharges, but it can also have galvanic contact to the yoke step 41, whereby it is also grounded. In the example of FIG. 2, the yoke-side 2 end of the leakage flux guide 10 is located at the distance of 1 mm from the first step 41 of the yoke 2, but it is advantageous to leave the distance to the second step 42 of the yoke 2 larger, for instance, 5 mm, whereby the leakage flux is mainly directed from the upper part of the first step 41 of the yoke 2 via the yoke plate ends to the yoke and does not cause excessive heating within the area of the step 42. The leakage flux can be conducted to the yoke 2 via a plurality of yoke steps, as illustrated in FIG. 3, for instance, such that two or more flux guides 18 and 19 are superimposed such that their ends are disposed at different steps of the yoke 2. By this arrangement the leakage flux can be conducted to the core more steadily via a larger surface, whereby the risk of local heating is reduced at the magnetic joint of the leakage flux guide and the transformer core. As appears from FIG. 1, the leakage flux can also be directed via another path to the transformer core, for instance, to the pole 3 by the leakage flux guides 13 and 14. It is also advantageous to ground the leakage flux guides 10 to 19. That is most advantageous to perform in such a manner that the point of the leakage flux guide 10 to 19 that is remotest from the winding 4 is connected, for instance, to the clamping bar 1 e.g. by a copper wire (not shown in the figures).

The leakage flux guides 10 to 19 are advantageously manufactured by lamination, for instance of transformer plates that are interconnected, for instance, by spot welding or in some other suitable manner. As appears from FIG. 1, the leakage flux guides 10 to 19 are advantageously bent at least at one point, whereby they cover the clamping bar 1 better and take less space. The appearance of the leakage flux guides used may deviate from what is presented in the figures without deviating from the basic idea of the invention. It is most advantageous to manufacture the leakage flux guides to have such a form that the number of different shapes and sizes required is as small as possible. For instance in FIG. 1, the leakage flux guides 10 to 12 and 15 to 17 are advantageously mutually identical in shape and size, which reduces the number of required variations and thus reduces manufacturing costs.

It is apparent to a person skilled in the art that, as technology progresses, the basic idea of the invention can be implemented in a variety of ways. Thus, the invention and its embodiments are not restricted to the above-described examples but they may vary within the scope of the claims.

1. An arrangement for reducing leakage flux of a transformer or the like conducted to a clamping bar, the transformer comprising a laminated, magnetic core, which comprises at least two poles that are interconnected with yokes such that the core forms at least one loop, clamping bars that are located on the sides of the yokes and that press the layers of the core together, and windings disposed in at least one pole, whereby the portion of magnetic flux associated with electric currents passing in the windings, which passes outside the core is a leakage flux, the arrangement comprising:
one or more leakage flux guides for at least one transformer pole provided with the windings, the leakage flux guides being arranged such that they are securable to the clamping bar at points that are free from obstacles associated with the clamping bar such that they cover a portion of the clamping bar substantially at the windings and that the magnetic connection of the leakage flux guides to the core is substantially better than the magnetic connection to the clamping bar, and which leakage flux guides are bent at least at one point such that they cover at least two sides of the clamping bar, whereby they direct the leakage flux conducted therein mainly to the core and reduce the conduction of the leakage flux to the clamping bar.

2. An arrangement as claimed in claim 1, wherein the leakage flux guides are plate-like pieces, whereby the magnetic connection of at least one edge of each guide to the core is arranged such that the magnetic flux conducted to the leakage flux guide is mainly conducted via said at least one edge to the core.

3. An arrangement as claimed in claim 1 or 2, wherein the leakage flux guides consist of laminated metal plates that are interconnected, such as transformer plates.

4. An arrangement as claimed in claim 1 or 2, comprising two or more leakage flux guides superimposed such that they direct the conducted leakage flux to different points in the core.

5. A transformer or the like, comprising:
a laminated, magnetic core, which comprises at least two poles, which are interconnected with yokes such that the core forms at least one loop,
clamping bars on the sides of the yokes, which clamping bars press the core layers together,
windings disposed in at least one pole, whereby the portion of magnetic flux associated with electric currents passing in the windings, which passes outside the core is a leakage flux, and
one or more leakage flux guides in at least one clamping bar for at least one pole provided with the windings, the leakage flux guides being secured to the clamping bar at points free from obstacles associated with the clamping bar such that they cover a portion of the clamping bar substantially at the windings and that the magnetic connection of the leakage flux guides to the core is better than the magnetic connection to the clamping bar, and which leakage flux guides are bent at least at one point such that they cover at least two sides of the clamping bar, whereby they direct the conducted leakage flux mainly to the core reducing the conduction of the leakage flux to the clamping bar.

6. A transformer as claimed in claim 5, wherein the leakage flux guides are plate-like pieces, whereby the magnetic connection of at least one edge of each guide to the core is arranged such that the magnetic flux conducted to the leakage flux guide is mainly conducted via said at least one edge to the core.

7. A transformer as claimed in claim 5 or 6, wherein the leakage flux guides consist of laminated metal plates that are interconnected, such as transformer plates.

8. A transformer as claimed in claim 5 or 6, comprising two or more leakage flux guides superimposed such that they direct the conducted leakage flux to different points in the core.
